(19) United States
(12) Patent Application Publication
(10) Pub. No.: US 2016/0274769 A1
(43) Pub. Date: Sep. 22, 2016

(54) IMAGE PROCESSING APPARATUS, IMAGE PROCESSING METHOD, AND IMAGE PROCESSING PROGRAM

(71) Applicant: FURYU CORPORATION, Tokyo (JP)

(72) Inventors: Wakako SAKAHARA, Kyoto (JP); Kazuto KATADA, Osaka (JP); Ryoko INAGAKI, Osaka (JP)

(73) Assignee: FURYU CORPORATION, Tokyo (JP)

(21) Appl. No.: 14/986,633

(22) Filed: Jan. 1, 2016

(30) Foreign Application Priority Data
Mar. 17, 2015 (JP) 2015-054009

(51) Int. Cl. G06F 3/0484; G06T 11/60; G06F 3/0488

(52) U.S. Cl. CPC G06F 3/04845; G06F 3/04842; G06F 3/04883; G06F 3/04847; G06T 11/60; G06T 2200/24

(57) ABSTRACT

The image processing apparatus includes a photographing device configured to photograph a user to generate a photographed image; a display device configured to display a content image selection screen with which the user selects a content image to be composited with the photographed image out of a plurality of content images and an instruction receiving device configured to receive selection of a first content image by a user on the content image selection screen. The display device displays an operation region including the first content image, moves and displays the first content image in accordance with movement of the operation region corresponding to an operation of the user, and fixes the selection of the first content image when detecting a touch made by the user in a region other than the content image selection screen and other than the operation region.

### BACKGROUND OF THE INVENTION

1. Technical Field

The present invention relates to an image processing apparatus for editing and printing a photographed image on a sticker sheet.

2. Related Art

Conventionally, a photo sticker creating apparatus is known that photographs a user (object) and that edits and prints a photographed image on a sticker sheet to provide the image as a photo sticker or to transmit the image as a photo image to a user's portable terminal (see, e.g., Patent Documents 1 (JP2011-114744A), 2 (JP2010-154452A), and 3 (JP4908626B)).

Patent Document 1 discloses that the photo sticker machine changes content images such as stamp images to content images having depth and pastes the changed content images to photographed images, so as to look like real images. Patent Document 2 discloses that the photo sticker machine adjusts so as to fit an image for SNS (an image for portable-terminal transmission) by trimming away a photographed image in itself, rotating and scaling up/down the trimmed photographed image.

### SUMMARY OF THE INVENTION

In Patent Document 1, an adjustment condition of a rotation angle is confirmed by pasting the content image, which is acquired by changing a rotation angle of a content image selected within a contents palette, to a photographed image. In case that the rotation angle of the once confirmed content image does not match a user's preference, the user needed to confirm by pasting the content image, which was again adjusted within the contents palette, to the photographed image. In Patent Document 2, since a photographed image is trimmed and rotated, in case that the image is edited, the user changed a size of a content image and rotated the changed content image in a size within a contents palette so as to fit the photographed image. Therefore, in case that the content image does not match a user's preference, the user needed to confirm by pasting the content image, which was again adjusted within the contents palette, to the photographed image, similarly to Patent Document 1.

An object of the present invention is to solve the aforementioned problems and provide an image processing apparatus, an image processing method, and an image processing program capable of facilitating a work of readjustment of a size or a rotation angle (direction), etc. of a content image to be pasted to a photographed image.

An image processing apparatus according to the present invention includes:

a photographing device configured to photograph a user to generate a photographed image;

a display device configured to display a content image selection screen with which the user selects a content image to be composited with the photographed image out of a plurality of content images; and

an instruction receiving device configured to receive selection of a first content image by a user on the content image selection screen.

The display device configured to display an operation region including the first content image, moves and displays the first content image in accordance with movement of the operation region corresponding to an operation of the user, and fixes the selection of the first content image when detecting a touch made by the user in a region other than the content image selection screen and other than the operation region.

An image processing method according to the present invention includes:

photographing a user to generate a photographed image;

displaying a content image selection screen with which the user selects a content image to be composited with the photographed image out of a plurality of content images; and

receiving selection of a first content image by a user on the content image selection screen.

The displaying includes:

displaying an operation region including the first content image;

moving and displaying the first content image in accordance with movement of the operation region corresponding to an operation of the user; and

fixing the selection of the first content image when detecting a touch made by the user in a region other than the content image selection screen and other than the operation region.

A non-transitory computer-readable storage medium according to the present invention stores an image processing program for allowing a computer to execute the image processing method as described above.

According to the present invention, In case that a content image in the contents palette is replaced, the content image can be replaced with a new content image to be pasted while retaining the attributes (position, size, direction (rotation angle)) of the content image before the replacement. Therefore, it is possible to reduce an edit time and an effort of the stamp image.

### BRIEF DESCRIPTION OF DRAWINGS

FIG. 1A is a perspective view of a photo sticker creating apparatus according to one embodiment of the present invention.

FIG. 1B is a perspective view of a photo sticker creating apparatus according to one embodiment of the present invention.

FIG. 2A is a front view of the photo sticker creating apparatus.

FIG. 2B is a rear view of the photo sticker creating apparatus.

FIG. 3 is a diagram showing internal constitutes of the photo sticker creating apparatus.

FIG. 4 is a diagram for explaining user's spatial movement during a photo sticker creating game.

FIG. 5 is a flowchart showing a series of operations related to the photo sticker creating game by the photo sticker creating apparatus 1.

FIG. 6 is a diagram showing an example of the stamp image pasting process. In this case, the number of users is set to be two and two edit screens 400 are prepared on a display screen 300 so that each of the users can write graffiti.

FIG. 7 is a flowchart of the stamp image pasting process executed by the photo sticker creating apparatus 1 according to the present invention.

FIG. 8 is a flowchart showing in detail the stamp image selecting process (step S9) of FIG. 7.

FIG. 9 is a diagram showing one example of the operation button.

FIG. 10 is a diagram showing one example of a delete button (trash box) 106.

FIG. 11 is a diagram showing an example of a scale-down operation of the stamp image 100.

FIG. 12 is a diagram showing an example of a rotation operation of the stamp image 100.

FIG. 13 is a diagram showing one example of a list 105.

FIG. 14A is a diagram for concretely describing the process of step S15 of FIG. 7.

FIG. 14B is a diagram for concretely describing the process of step S15 of FIG. 7.

FIG. 14C is a diagram for concretely describing the process of step S15 of FIG. 7.

FIG. 15A is a diagram showing one example of an operation of an operation area 200.

FIG. 15B is a diagram showing one example of an operation of the operation area 200.

FIG. 15C is a diagram showing one example of an operation of the operation area 200.

FIG. 16A is a diagram showing one example of an operation of the operation area 200.

FIG. 16B is a diagram showing one example of an operation of the operation area 200.

FIG. 17 is a diagram showing one example of a non-editable stamp images.

FIG. 18A is a diagram showing one example of an e-mail address entry screen.

FIG. 18B is a diagram showing one example of a message displayed on a screen after an e-mail transmission button is pressed.

FIG. 18C is a diagram showing one example of a message displayed on a screen after an e-mail transmission button is pressed.

FIG. 18D is a diagram showing one example of a message displayed on a screen after an e-mail transmission button is pressed.

### DETAILED DESCRIPTION OF EMBODIMENTS

A specific embodiment of the present invention will now be described with reference to the accompanying drawings.

### First Embodiment

A photo sticker creating apparatus of one embodiment of the present invention is a game apparatus (game service providing apparatus) allowing a user to perform photographing, editing, and the like as a game (game service) and providing a photographed/edited image as a photo sticker or data to the user. A photo sticker creating apparatus 1 is disposed in a game arcade, a shopping mall, a store in a tourist site, and the like.

In a game provided by the photo sticker creating apparatus, a user photographs himself/herself and the like with a camera disposed in the photo sticker creating apparatus. The user composes a foreground image and/or a background image to a photographed image, or edits the photographed image, thereby designing the photographed image into a colorful image. After the game ends, the user receives a photo sticker and the like printed with the edited image as a resulting product. Alternatively, the photo sticker creating apparatus provides the edited image to a user's portable terminal and the user can receive a resulting product with the portable terminal.

### 1. CONFIGURATION OF PHOTO STICKER CREATING APPARATUS

1.1. Appearance

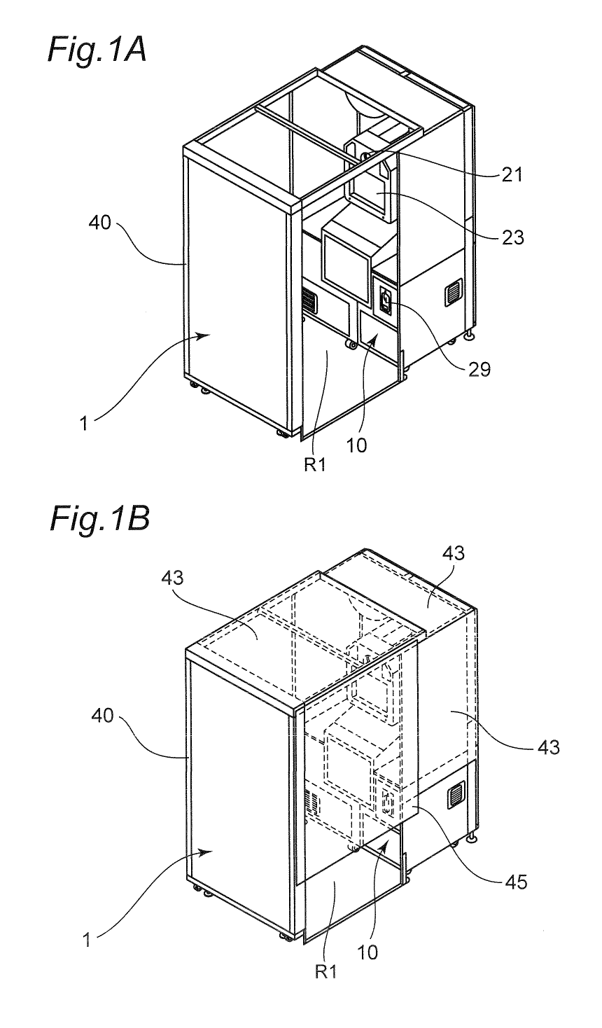

FIGS. 1A and 1B are diagrams respectively showing an appearance of a photo sticker creating apparatus according to one embodiment of the present invention. As shown in FIG. 1A, the photo sticker creating apparatus 1 is made up of a photographing unit 10 for photographing and editing and a background unit 40 for controlling a background during photographing. A space between the photographing unit 10 and the background unit 40 constitutes a photographing space R1 in which a user performs a photographing.

When disposed and used in a game arcade etc., as shown in FIG. 1B, the photo sticker creating apparatus 1 of an image processing apparatus is disposed in such a state that a portion of an upper portion and a side portion of the photo sticker creating apparatus 1 is covered with a shielding sheet 43. Further, the photo sticker creating apparatus 1 is disposed in such a state that an opening portion (entrance/exit for a user) between the photographing unit 10 and the background unit 40 is covered with a curtain 45 on a lateral side. In this way, the space inside the photo sticker creating apparatus 1 (the photographing space R1) is shielded from the outside by the curtain 45. This allows a user to photograph an image in the photographing space R1 without caring about people's eyes on the outside. On the other hand, the curtain 45 does not cover the lower portion of the opening portion (entrance/exit) on the lateral side of the photo sticker creating apparatus 1, and therefore, the photographing space R1 is prevented from being completely closed for security reasons. The curtain 45 and the shielding sheet 43 are printed with an image for advertisement, information on procedures of the game of the photo sticker creating apparatus 1, and the like.

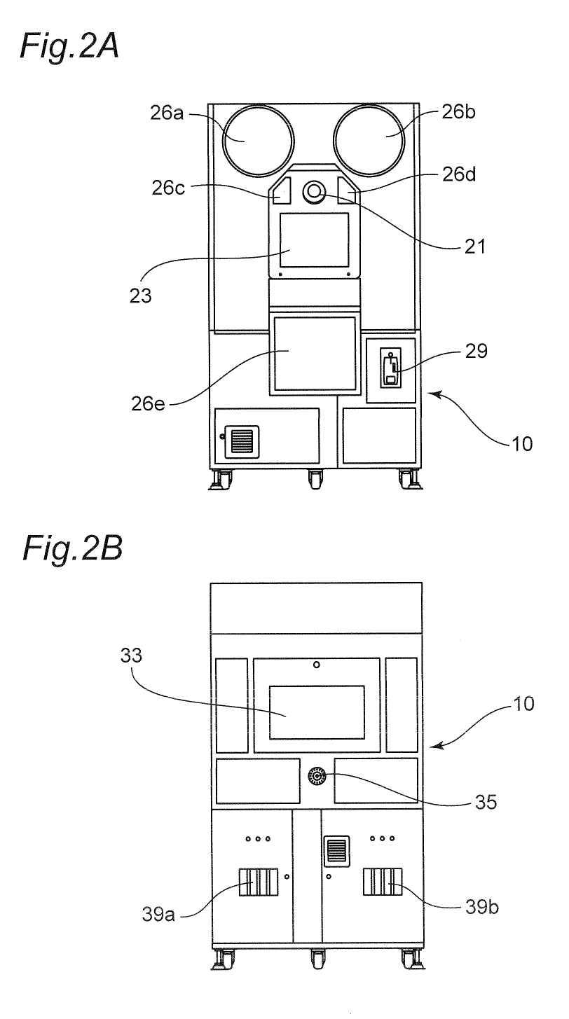

FIGS. 2A and 2B show a front view and a rear view, respectively, of the photographing unit 10. As shown in FIG. 2A, a front face of the photographing unit 10 is disposed with a camera 21, illumination apparatuses 26a to 26e, a touch panel monitor 23, and a coin insert/return slot 29. It is noted that a bill/credit-card reader or a money changer may be disposed instead of the coin insert/return slot.

The camera 21 photographs an image of an object (user) to generate a photographed image. The camera 21 is made up of an imaging element such as a CCD (charge-coupled device) or CMOS (complementary metal oxide semiconductor) image sensor. The camera 21 is not limited to the example shown in FIG. 2 in terms of the position and the number of the camera 21

The touch panel monitor 23 displays guidance, a demonstration screen, etc. of the photo sticker creating game and a game method thereof. The touch panel monitor 23 accepts an instruction from a user through a touch operation. The touch panel monitor 23 is made up of an LCD (liquid crystal display), an organic EL display, etc. A colorless and transparent touch sensor (e.g., of a pressure-sensitive or electromagnetic induction type) is superimposed on a screen of the touch panel monitor 23 and positional information (instruction from a user) can be input by touching with, for example, a stylus pen or a user's finger. The touch panel monitor 23 displays a background image selection screen that is a GUI for selecting an image of background and/or foreground (composition image) to be composited with the photographed image generated by the camera 21.

The illumination apparatuses 26a to 26e are apparatuses for irradiating an object with illumination light during photographing of an image of the object. The illumination apparatuses 26a to 26e are made up of a fluorescent light, a LED (light emitting diode) illumination device, an illumination device capable of stroboscopic light emission, etc.

The coin insert/return slot 29 is an opening portion for allowing a user to input a charge for the photo sticker creating game and to receive the change etc. A side surface of the photographing unit 10 is disposed with a speaker (not shown) for outputting a guidance sound, a sound effect, etc. to a user in the photographing space R1.

As shown in FIG. 2B, the rear face of the photographing unit 10 is disposed with a tablet built-in monitor 33, a speaker 35, and sticker discharge ports 39a, 39b.

The tablet built-in monitor 33 displays an edit screen that is a GUI (graphical user interface) for editing a photographed image generated by a photographing operation in the photographing space R1. The edit screen is formed to concurrently display two images to be edited so that a pair of users uses respective stylus pens to separately edit graffiti. The two concurrently displayed images targeted for the graffiti editing may be the same images or different images.

The tablet built-in monitor 33 is made up of a tablet to which positional information can be input with a stylus pen, and a monitor having a display device capable of displaying an image. The tablet is, for example, a pressure-sensitive or electromagnetic induction type input device (touch sensor), is colorless and transparent, and is superimposed and disposed on a display screen of the display device. The display device is made up of an LCD (liquid crystal display), an organic EL display, etc. Therefore, the tablet built-in monitor 33 not only simply displays a GUI image etc. by the display device but also accepts an input operation from a user by the tablet. The tablet built-in monitor 33 may include a touch panel monitor and may allow the user to input information with a finger etc.

The speaker 35 outputs sounds such as a guidance sound, a sound effect, and BGM related to an edit operation of the photo sticker creating game. It is noted that the number, design, shape, and the like of the disposed speakers 35 are arbitrary.

The sticker discharge ports 39a, 39b discharge a photo sticker generated by reflecting the selection made in the photographing space R1 and details of editing performed in an editing space R2 based on the photographed image photographed in the photographing space R1.

1.2. Internal Configurations

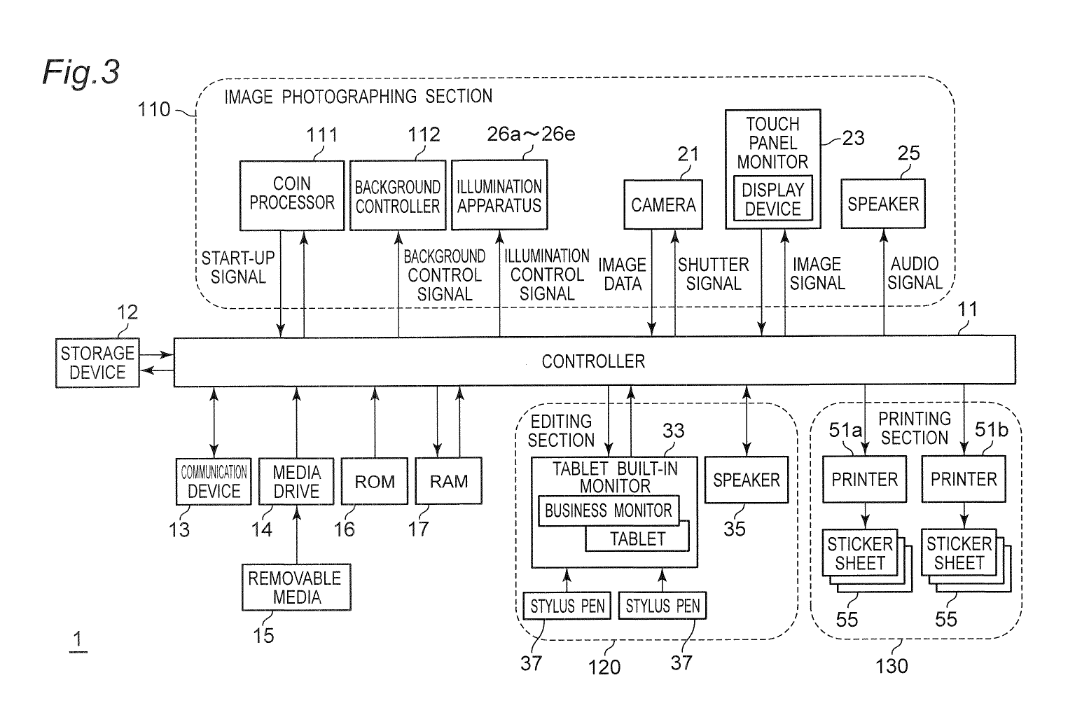

Internal configurations of the photo sticker creating apparatus 1 will be described below. FIG. 3 is a block diagram showing one example of a functional configuration of the photo sticker creating apparatus 1. The same constituent elements as the constituent elements described above are denoted by the same reference numerals and will not be described.

As shown in FIG. 3, the photo sticker creating apparatus 1 has a controller 11 for controlling an overall operation of the photo sticker creating apparatus 1. The controller 11 is respectively connected via a predetermined bus to a storage device 12, a communication device 13, a media drive 14, a ROM (read only memory) 16, a RAM (random access memory) 17, an image photographing section 110, an editing section 12, and a printing section 130. The controller 11 is made up of a CPU or an MPU and executes a predetermined program to implement general functions of the photo sticker creating apparatus 1 including functions described below. The predetermined program may be installed in the photo sticker creating apparatus directly or through a communication line from a predetermined recording medium. The predetermined recording medium includes, for example, magnetic disks such as a hard disk drive (HDD), a solid state drive (SSD), and a floppy (registered trademark) disk, optical disks such as CD (compact disc), DVD (digital versatile disc), and BD (Blu-ray disc) (registered trademark), magnetic optical discs such as MD (mini disc) (registered trade mark), or a removable medium such as a memory card. It is noted that the controller 11 may be designed as a dedicated electronic circuit for implementing a predetermined function. That is, the controller 11 may be made up of CPU, MPU, DSP, FPGA, ASIC, or ASSP.

The storage device 12 includes a non-volatile storage medium such as a hard disk drive (HDD), a flash memory, and a solid state drive (SSD). The storage device 12 stores various pieces of configuration information and reads and supplies the stored configuration information to the controller 11. The recording medium making up the storage device 12 may be any non-volatile recording medium.

The communication device 13 communicates with another communicating device (not shown) through an external network (not shown) such as the Internet and a public telephone network, for example, or simply through a communication cable (not shown). That is, the communication device 13 communicates with another communication device such as a user's portable telephone, a user's personal computer, or central management server under the control of the controller 11. For example, the communication device 13 transmits transmission information supplied from the controller 11 to another communication apparatus and supplies reception information supplied from another communication apparatus to the controller 11.

The media drive 14 is loaded with a removable medium 15 such as a magnetic disk (including a flexible disk), an optical disk (such as CD, DVD, and BD), a magnetic optical disk, or a semiconductor memory (USB memory). A computer program and data are read from the removable medium 15 and supplied to the controller 11 or stored or installed in the storage device 12 etc.

The ROM 16 preliminarily stores the program and data executed by the controller 11. The ROM 16 supplies the program and data to the controller 11 based on an instruction of the controller 11. The RAM 17 temporarily keeps the data and program executed by the controller 11.

The image photographing section 110 is a block related to a photographing process and has a coin processor 111, a background control portion 112, the illumination apparatuses 26a to 26e, the camera 21, the touch panel monitor 23, and a speaker 25.

The camera 21 captures a moving image for live-view display before photographing and outputs the image data of the captured moving image to the controller 11. The camera 21 outputs to the controller 11 the image data acquired by photographing, which is performed based on an instruction from a user of an object. In this case, when receiving the image data from the camera 21, the controller 11 generates an image signal based on the received image data and outputs the image signal to the touch panel monitor 23.

When receiving the image signal from the controller 11, the touch panel monitor 23 displays on a display device a still image or a moving image (live view) of the photographed object based on the received image signal.

The coin processor 111 counts coins inserted from the coin insert/return slot 29 and transmits a signal indicative of a counted amount to the controller 11. The controller 11 determines whether coins are inserted in a predetermined amount based on the signal from the coin processor 111. The background control portion 112 controls a background curtain hung as a background behind an object (on the background unit side) in the photographing space R1. That is, the background control portion 112 hangs and houses the background curtain under the control of the controller 11. It is noted that the background unit 40 may have structure with a chroma-key composition curtain affixed to a sheet metal. Alternatively, the background unit 40 may be made up only of a sheet metal painted in predetermined color (e.g., green). The color of the sheet metal may be color such as white matched to a background image. In case that hanging/housing the background curtain does not have to be controlled in the background unit 40, the background control portion 112 may not be included.

An editing section 120 is a block related to an edit process, and includes the tablet built-in monitor 33, a stylus pen 37, and the speaker 35.

The printing section 130 includes two printers 51a and 51b for printing a result of edit operation performed by the editing section 120 on a sticker sheet 55. Hereinafter, the printer 51a disposed on the left side viewed from the rear side of the photo sticker creating apparatus 1 will be referred to as a “first printer” and the printer 51a disposed on the right side will be referred to as a “second printer.” Only one printer is operated between the first printer 51a and the second printer 51b. The other printer is secondarily used instead of the printer in operation when sticker sheets run out in the printer in operation or when the printer in operation fails. The first and second printers 51a and 51b acquire image information edited by the controller 11 for printing on the sticker sheet 55. When completing a printing process, the first and second printers 51a and 51b discharge the printed sticker sheet 55 from the sticker discharge ports 39a, 39b. This printed sticker sheet 55 is provided to a user as a photo sticker that is a resulting product of the photo sticker creating game.

### 2. OPERATION OF PHOTO STICKER CREATING APPARATUS

2.1. Flow of Photo Sticker Creating Game

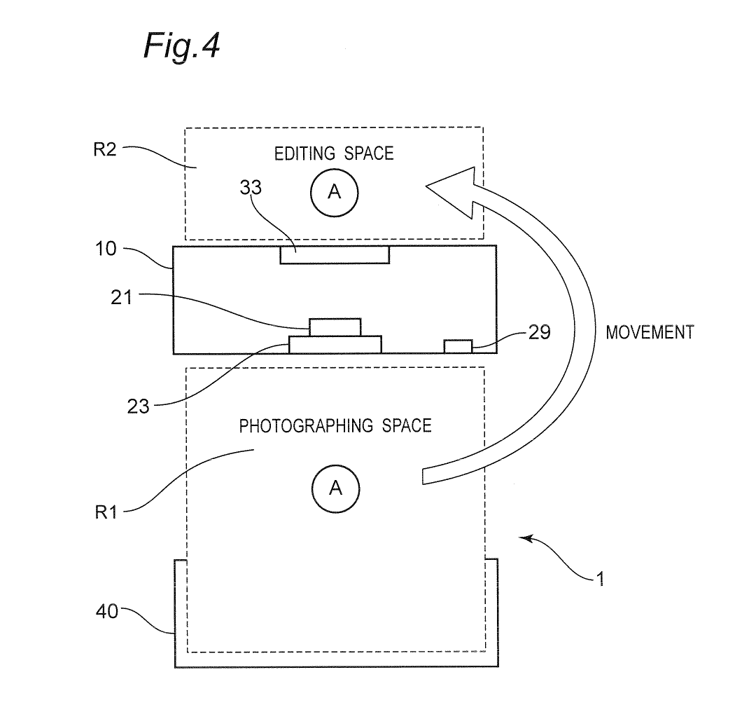

A flow of a photo sticker creating game by the photo sticker creating apparatus 1 and user's movement associated therewith will be described with reference to FIG. 4.

FIG. 4 is a diagram for explaining user's spatial movement during the game. FIG. 4 shows a view when the photo sticker creating apparatus 1 is viewed in its entirety from above. As shown in FIG. 4, a user A enters the photographing space R1 from a lateral side of the photo sticker creating apparatus 1 and puts the charge into the coin insert/return slot 29 of the photographing unit 10 to start the photo sticker creating game. Subsequently, the user A selects a background image and photographs and image with the camera 21 in the photographing space R1. That is, in the photographing space R1, the user A utilizes the camera 21 and the touch panel monitor 23 disposed in the front face of the photographing unit 10 to select the background image to be composited with a photographed image and to photograph an image of the user A and the like (the photographing operation).

When completing the selection of the background image and the photographing, the user A moves to the editing space R2 located behind the photographing unit 10 in accordance with guidance (leading) of the photo sticker creating apparatus 1. The user A operates the tablet built-in monitor 33 to perform an edit operation such as writing graffiti on the photographed image in the editing space R2. It is noted that, If a user of the preceding group is using the editing space R2 (performing the edit operation) when the selection of the background image and the photographing are completed in the photographing space R1, the photo sticker creating apparatus 1 does not guide the user A to the editing space R2. In this case, the user A waits in the photographing space R1 until the editing space R2 becomes available. Subsequently, when the user of the preceding group terminates the edit operation, the photo sticker creating apparatus 1 guides the user A to the editing space R2 and the user A moves to the editing space R2 in accordance with the guidance. When it is determined that operations are concurrently performed in the photographing space R1 and the editing space R2, the photo sticker creating apparatus 1 may control the photographing process such that a photographing time becomes longer in the photographing space R1 or may control the edit process such that an edit time becomes shorter in the editing space R2, so as to reduce the waiting time of the user.

As described above, it is possible to separate the photographing space R1 for photographing and the editing space R2 for editing an image, and therefore, it is possible to guide different users to the respective spaces. Therefore, two groups of users can enjoy games at the same time in the one photo sticker creating apparatus 1. Thus, as compared to the case where the photographing and editing are performed in one space, it is possible to increase a rate of operation of the photo sticker creating apparatus 1.

It is noted that, in the example described above, the photographing and the selection of the background image are performed in the photographing space R1 and the graffiti process and the printing process are executed in the editing space R2. However, a photo sticker creating apparatus may be configured such that the photographing, the selection of the background image, the graffiti edit, and the printing are performed in respective different spaces. In case that a plurality of processes is executed in one space as described above, although the photo sticker creating apparatus 1 can advantageously be reduced in size to make a footprint smaller, even when respective different groups of users concurrently perform operations in the respective spaces, only the two spaces are available for operations, and therefore, the number of groups of users capable of concurrently using the apparatus sets to be at most two. However, in case that the processes are executed in respective different spaces, it is possible to increase the number of users concurrently using the apparatus, and to improve a turnover rate. On the other hand, the footprint of the photo sticker creating apparatus 1 becomes relatively larger, and therefore, a disposition location must have a relatively large area.

The configuration of units of the photo sticker creating apparatus 1 is arbitrary and a unit configuration other than the described configuration may be used. A method of serving to multiple customers is arbitrary. For example, one photographing space and two editing spaces may be disposed. This configuration can improve the turnover rate of the photo sticker creating apparatus. Alternatively, two photographing spaces and two editing spaces may be disposed, respectively. In this case, since two (i.e., multiple) spaces are disposed for each of the photographing and the editing, it is possible to further improve the turnover rate of the photo sticker creating apparatus.

2.2. Overall Operation

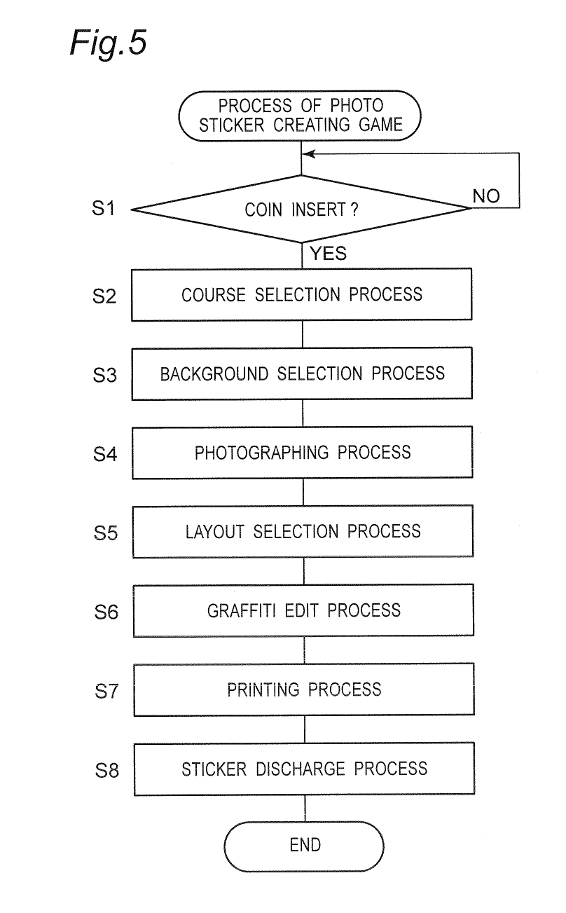

An operation related to the photo sticker creating game of the photo sticker creating apparatus 1 will be described. As described above, the photo sticker creating apparatus 1 composites a foreground or a background with a user's photographed image, and prints and outputs the image subjected to an edit process such as writing graffiti on a sticker sheet. FIG. 5 is a flowchart showing a series of operations related to the photo sticker creating game in the photo sticker creating apparatus 1. An overall operation of the photo sticker creating apparatus 1 will be described below with reference to the flowchart of FIG. 5.

When a user puts coins into the coin insert/return slot 29 in a predetermined amount required for playing the game in the photo sticker creating apparatus 1 (S1), the controller 11 starts the photo sticker creating game. It is noted that, among processes described below, a course selection process (S2), a background selection process (S3), a photographing process (S4), and a layout selection process (S5) are executed for a user present in the photographing space R1. A graffiti edit process (S6), a printing process (S7), and a sticker discharge process (S8) are executed for a user present in the editing space R2.

First, the controller 11 executes the course selection process (S2). In the present embodiment, one course can be selected from a plurality of courses. In the present embodiment, for example, a “normal course” and an “easy course” are prepared. The easy course is a course intended for a user unfamiliar with the operation of the photo sticker creating apparatus 1 and is a course in which the user can proceed with the game through an operation simpler than the normal course. The controller 11 displays a course selection screen with which the user selects a course of the game on the touch panel monitor 23 of the image photographing section 110. The user operates the touch panel monitor 23 on the course selection screen to select a desired course. The controller 11 stores the information of the course selected by the user in the RAM 17.

After termination of the course selection process (S2), the controller 11 performs the background selection process (S3). In the background selection process, a background or foreground image to be composited with the photographed image is selected based on an instruction from a user. It is noted that the background image or the foreground image is collectively referred to as “background image” for convenient in the following descriptions. The background selection process (S3) will be described below in detail.

After termination of the trimming range selection process (S3), the controller 11 executes the photographing process (S4). In the photographing process, the controller 11 controls the portions of the image photographing section 110 to take an image (photograph) of the user (object). In this case, a plurality of images (photographs) of the user (object) is taken in series. This enables the user to photograph images in various poses. The number of photographed images may be the same as the number of arrangement regions of the images printed on a photo sticker. Alternatively, the number of photographed images may be made larger than the number of arrangement regions of the images printed on a photo sticker so that the user selects an image printed on a photo sticker out of the photographed images.

After termination of the photographing process (S4), the controller 11 displays a guidance screen for guiding the user to the editing space R2 on the touch panel monitor 23. The user moves to the editing space R2 in accordance with the display of the guidance screen displayed on the touch panel monitor 23 and subsequently performs an operation in the editing space R2. After termination of the photographing process (S4), the controller 11 further executes the layout selection process (S5).

The layout selection process is a process of determining a layout of a photo sticker. A plurality of photo sticker layouts is prepared in the photo sticker creating apparatus 1 so that a user selects a desired layout from a plurality of the layouts. The layout selection process will be described below in detail. It is noted that the layout selection process (S5) may be executed in the photographing space R1.

After termination of the layout selection process (S5), the controller 11 executes the graffiti edit process (S6). The graffiti edit process is a process of accepting decoration to a photographed image by a user. Concretely, the user can operate the stylus pen 37 on the tablet built-in monitor 33 disposed on the rear face of the photographing unit 10 in the editing space R2 so as to write graffiti (desired characters, graphics, drawings) on a photographed image. In addition, the user can operate the stylus pen 37 on the tablet built-in monitor 33 to give an instruction for pasting of a stamp image of a decoration image (a predetermined drawing pattern, a predetermined text, and a combination thereof) prepared in advance to the photographed image onto a desired region of the photographed image. In the graffiti edit process, the controller 11 accepts an instruction relate to a graffiti writing operation and a decoration image from a user and composites the line image generated by writing graffiti or the decoration image (stamp image) of the instruction with the photographed image. This graffiti process enables a user to create a photo sticker of favorite design.

It is noted that the contents of the graffiti edit operation provided to a user in the graffiti edit process differs depending on a course selected by the user at the start of the game. For example, since the easy course is intended for a user unfamiliar with the photo sticker creating game, a procedure of operation of writing graffiti is made easier or the number of types of selectable operations is reduced as compared to the normal course. On the other hand, more various and complicated functions are provided to a user in the normal course as compared to the easy course so that the user can more elaborately write desired graffiti. It is noted that, although the operation is performed by using the stylus pen 37 in the above description, the operation may be performed by using a finger.

After termination of the graffiti edit process (S6), the controller 11 executes the printing process (S7) and the sticker discharge process (S8). In the printing process, the controller 11 edits an image for print based on the background image selected in the background selection process (S3), the layout selected in the layout selection process (S5), and the contents of the graffiti and decoration image of the instruction given in the graffiti edit process (S6). The controller 11 controls the printers 51a and 51b in the printing section 130 to print the edited image on the sticker sheet 55. After the printing is completed, the sticker sheet 55 printed with the edited image is discharged from either of the sticker discharge ports 39a, 39b. In a post customer process corresponding to a waiting time of the printing process, the controller 11 prompts the user to enter an e-mail address or an ID for SNS and transmits the image data through the communication device 13 to an external server. The user can download the image data from the server to a smartphone etc., of the user to enjoy the image data.

As a result of the procedures as described above, a photo sticker is generated that includes an image acquired by applying desired decoration to a user's image.

A process (stamp image pasting process) at the time of pasting a stamp image 100 to a photographed image in the graffiti edit process (S6) will be described by a concrete example.

2.3. Stamp Image Pasting Process

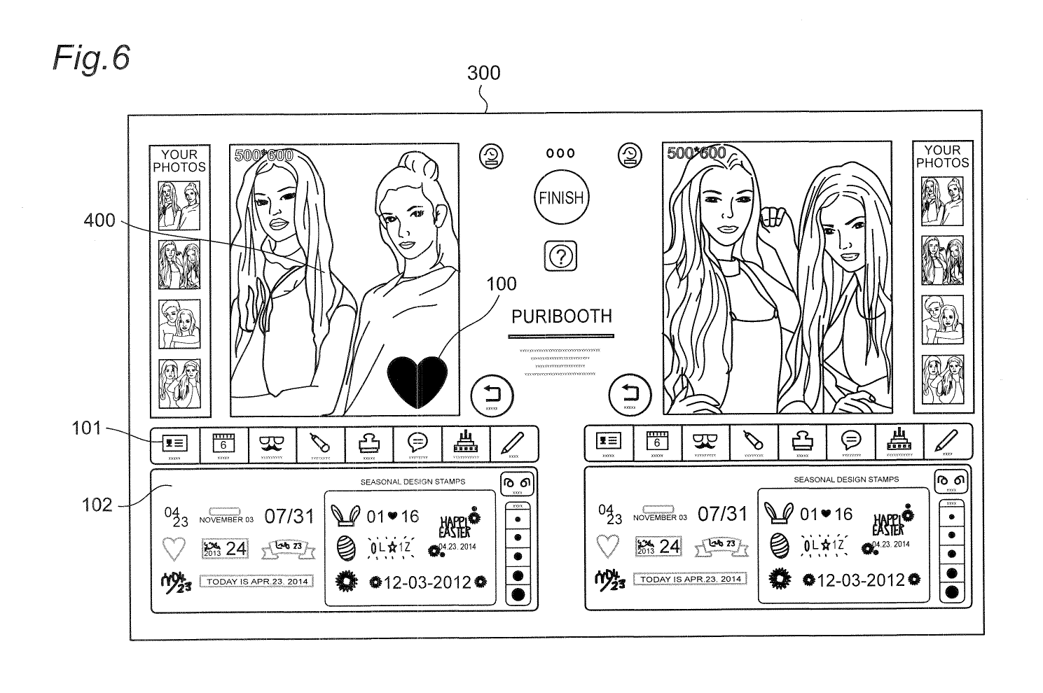

FIG. 6 is a diagram showing an example of the stamp image pasting process. In this case, the number of users is set to be two and two edit screens 400 are prepared on a display screen 300 so that each of the users can write graffiti. As shown in FIG. 6, the users can paste the stamp images 100 displayed within contents palettes (content image selection screens) 102 to the edit screens 400. In this case, the heart-shaped stamp image 100 is pasted to the (left) edit screen 400. In addition, the content images within the contents palettes 102 are switched to the display of different content images by switching the tabs 101.

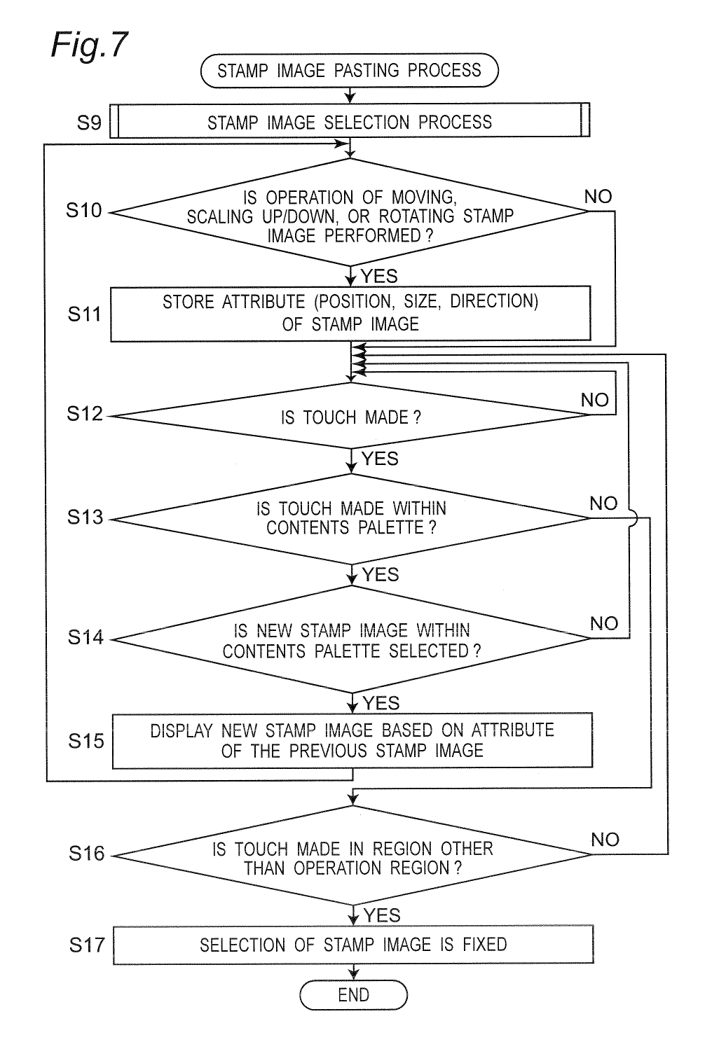

FIG. 7 is a flowchart of the stamp image pasting process executed by the photo sticker creating apparatus 1 according to the present invention. In this case, description will be made of a process in a series of operations when a user first selects the stamp image 100 and performs an operation such as rotating the stamp image followed by selecting and pasting the new stamp image 100 as an example.

In FIG. 7, first, a stamp image selecting process is executed and the stamp image 100 is displayed on the edit screen 400 (step S9). The stamp image selecting process (step S9) will be described below in detail.

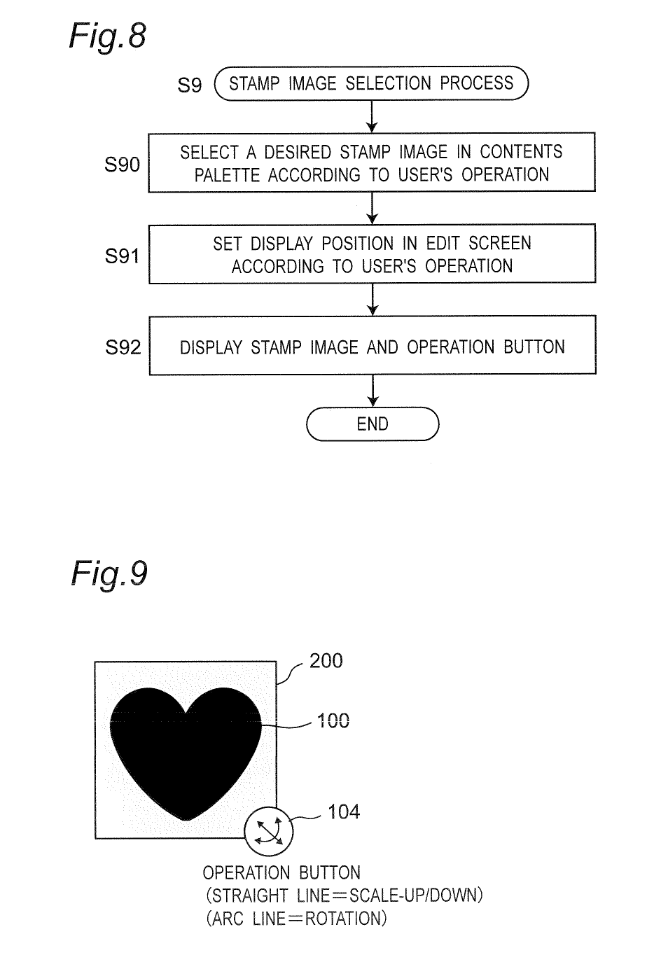

FIG. 8 is a flowchart showing in detail the stamp image selecting process (step S9) of FIG. 7. First, the user touches and selects the desired stamp image 100 within the content palette 102. As a result, the controller 11 selects the selected stamp image 100 (step S90). Next, the user touches and designates a display position of the selected stamp image 100 within the edit screen 400. As a result, the controller 11 sets the display position of the stamp image to the designated position (step S91). The controller 11 displays the selected stamp image 100 at the designated display position within the edit screen 400 and also displays an operation button 104 (see FIG. 9 etc.) for scaling up/down and rotating the stamp image (step S92), and this process is terminated.

In this case, the operation button 104 displayed in step S92 will be described below in more detail.

FIG. 9 is a diagram showing one example of the operation button. As shown in FIG. 9, an operation region 200 (portion displayed in gray) is inside a region, which surrounds the displayed stamp image 100 (heart). The operation button 104 is displayed at the lower right of the operation region 200 for scaling up/down and rotating the stamp image 100 on the basis of the center of the stamp image 100. In particular, the stamp image 100 such as eyeglasses can be scaled and rotated on the basis of the center of the eyeglasses to be displayed the eyeglasses at an angle that matches the preference of the user.

In addition, when moving the stamp image 100 within the edit screen 400, the user can move the stamp image 100 in the operation region 200 by moving the operation region 200 in such a state that the user keeps touching this operation region 200. For example, when the small stamp image 100 such as eyelashes is moved with a finger or a stylus pen, it is conventionally difficult to move the stamp image 100 because the image is hidden by a tip of the finger or the stylus pen. In contrast, according to a method of moving the stamp image 100 of the present embodiment, the user can position the stamp image 100 while confirming the position thereof in detail without hiding the stamp image behind the finger or the stylus pen by touching the operation region 200 without touching the stamp image itself.

It is noted that the controller 11 may provide control such that the operation region 200 is displayed in the same size for all the stamp images 100 (such that the size of the operation region 200 is not changed). That is, in case that the stamp image 100 is scaled down, the controller 11 provides control such that the operation region 200 is retained in a region larger than the stamp image 100. In addition, the controller 11 may provide control such that the operation region 200 is displayed in dimensions (size) changed for each of the stamp images 100. In addition, the controller 11 provides control such that the size of the operation region 200 is not scaled down and is kept in the same size even when the stamp image 100 is scaled down (the range of the operation region 200 may be kept constant). In addition, the controller 11 may provide control such that the operation region 200 is scaled down to a predetermined size (lower limit of the size of the operation region 200) as the stamp image 100 is scaled down. With this control, the operation region 200 remains large even when the stamp image 100 is scaled down, and therefore, a user can perform an operation such as an operation of moving, rotating, or scaling up/down the stamp image 100 while viewing the scaled-down stamp image 100.

In this case, on the operation button 104 displayed at the lower right of the operation region 200, a drag in a straight arrow direction corresponds to a scaling operation and a drag in an arc arrow direction (touch movement) corresponds to a rotation operation. It is noted that although the controller 11 provides control such that the operation region 200 is displayed in gray, the controller 11 may provide control such that only a frame is displayed. In addition, although the operation button is displayed at the lower right of the operation region 200, the operation button may be displayed at the upper left of the operation region 200, and may be displayed in any place as long as a user can understand that the stamp image 100 is to be edited. Further, the operation button may have only the operation function of scaling-up/down

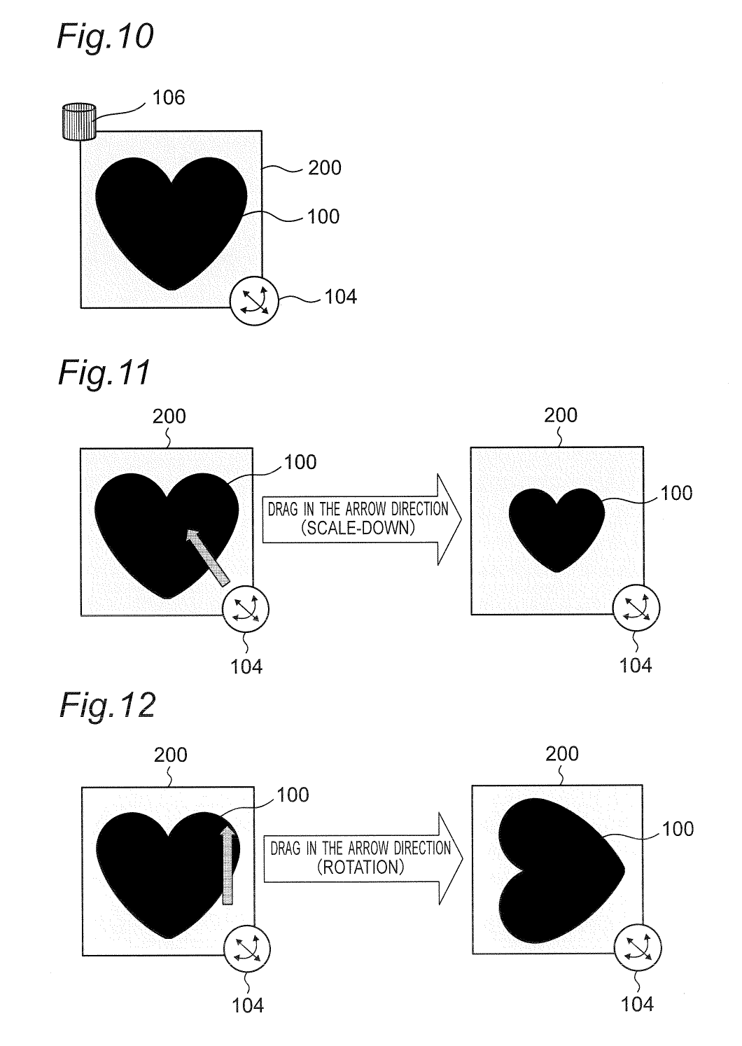

As shown in FIG. 10, a delete button (trash box) 106 for deleting the selected stamp image 100 may further be included. When the user touches the delete button 106 of a trash can mark, the stamp image (heart) 100 and the operation button 104 are deleted from the edit screen 400.

FIG. 11 is a diagram showing an example of a scale-down operation of the stamp image 100. As shown in FIG. 11, when the operation button 104 is touched and dragged (touch-moved) in the arrow direction by the user, the stamp image (heart) 100 is scaled down. In this case, the stamp image is rotated by dragging in a range of 45 to 90 degrees and is scaled up/down by movement at 45 degrees.

FIG. 12 is a diagram showing an example of a rotation operation of the stamp image 100. As shown in FIG. 12, when the operation button 104 is touched and vertically dragged (touch-moved) in the arrow direction by the user, the stamp image (heart) 100 is rotated by 90 degrees. It is noted that an inversion operation button for performing this inversion operation may be displayed in the operation region 200. An inversion function is a function of inverting the stamp image horizontally by 180 degrees (horizontal inversion) and vertically 180 degrees (vertical inversion). In addition, a function of returning to an original angle may also be included. For example, the controller 11 may provide control to display a button for changing the angle of the stamp image 100 through the rotation operation and simultaneously retuning the angle to the angle before the change (an angle returning button). Further, after the rotation or scaling-up/down operation, the controller 11 may provide control to display a depth rotation (three-dimensionally rotating the stamp image 100 by 360 degrees around the stamp image 100) button. It is noted that when the user keeps pressing this button for a long time, the stamp image keeps rotating 360 degrees, and when the user releases (performs a touch-up) from the button, the stamp image stops rotating at the angle at the time of the touch-up. Therefore, the user can easily intuitively adjust the angle corresponding to the stamp image 100. In addition, the controller 11 may provide control to display these inversion operation button and the depth rotation button depending on the stamp image 100. For example, the inversion operation button and the depth rotation button are displayed for the stamp image 100 such as eyeglasses having an inclination relative to a person.

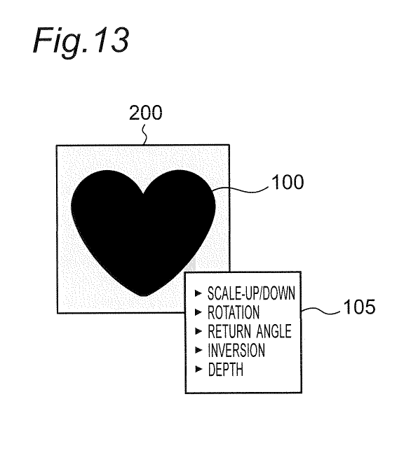

In addition, the controller 11 may provide control so as to display an undo button (for returning to the previous operation) for each of the stamp images 100. For example, in case that the scaling operation is performed after the rotation operation is performed, pressing this undo button returns a state to that after the operation before the scaling-up/down operation. That is, the state after the rotation operation is implemented. Further, after the rotation and scaling-up/down operations, the controller 11 may provide control so as to display the inversion function, the angle retuning function, the depth rotation function, and the undo function in a list-up format. Furthermore, the controller 11 may provide control so as to display the rotation and scaling-up/down function, the inversion function, a horizontal function (the angle retuning function), the depth rotation function, and the undo function in a list-up format (FIG. 13) or may provide control so as to change the listed-up operation contents for each of the stamp images 100. It is noted that, as shown in FIG. 13, the controller 11 may provide control so as to display a list 105 of selectable operations listed at the lower right instead of the operation button.

Returning to step S10 of the stamp image pasting process of FIG. 7, the controller 11 moves, scales, and/or rotates the stamp image 100 in accordance with the operation of the operation button 104 by the user. That is, the controller 11 changes an attribute (position, size, direction) of the stamp image 100. The controller 11 determines whether an operation of moving, scaling up/down (scaling-up/down), or rotating the stamp image 100 is performed (step S10). If it is determined that an operation of moving, scaling-up/down, or rotating the stamp image 100 is performed in step S10 (YES in step S10), the controller 11 stores the attribute (position, size, direction) of the stamp image 100 after movement, scaling-up/down, and/or rotation into the storage device 12 (step S11). That is, when an attribute with respect to the content image is changed, the controller 11 stores the changed attribute into the storage device 12.

Next, the controller 11 determines whether another one of the stamp image 100 is newly selected in the contents palette 102. This determination will concretely be described below.

The controller 11 determines whether a touch is made at an arbitrary position on the screen by a user (step S12). If the controller 11 determined in step S12 that a touch is made on the screen (YES in step S12), it is determined whether a touch is made at an arbitrary position in the contents palette 102 (step S13). It is noted that, in step S12, the controller 11 repeats the process of step S12 until it is determined that a touch is made at an arbitrary position on the screen (NO in step S12).

If it is determined in step S13 that a touch is made at an arbitrary position in the contents palette 102 (YES in step S13), the controller 11 determines whether the stamp image 100 different from the currently selected stamp image 100 in the contents palette 102 is newly selected (step S14). If it is determined that the new stamp image 100 is selected (YES in step S14), the controller 11 displays the new stamp image 100 based on the attribute (position, size, direction (rotation angle)) of the previous stamp image 100 stored in the storage device 12 (step S15). That is, the controller 11 displays the newly selected stamp image 100 with the same attribute as the attribute of the previous stamp image 100 displayed in the edit screen 400. Next, returning to step S10 again, the controller 11 determines whether the new stamp image 100 is moved, scaled up/down, or rotated.

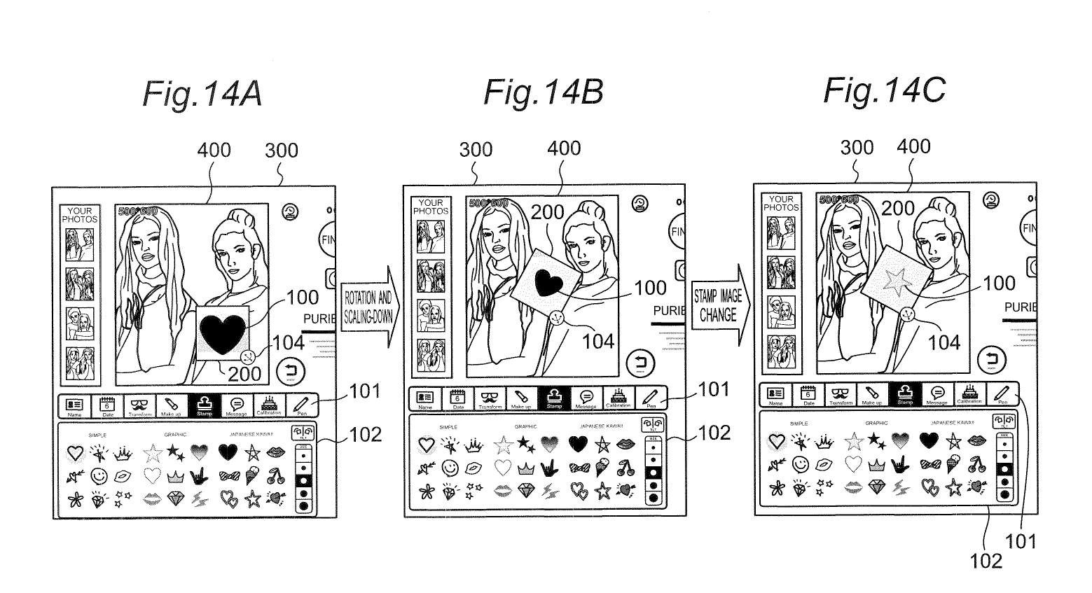

Each of FIGS. 14A to 14C is a diagram for concretely describing the process of step S15 of FIG. 7. As shown in FIGS. 14A to 14C, the user selects and displays the stamp image (heart) 100 on the edit screen 400 (FIG. 14A) and rotates the stamp image 100 shown in FIG. 14A with the operation button 104 as shown in FIG. 14B. Next, the user can then select the different stamp image (star) 100 out of the contents palette 102 instead of the stamp image (heart) 100 to newly paste the stamp image (star) 100 on the edit screen 400 while retaining the attribute of the stamp image (heart) 100 (FIG. 14C). Conventionally, in case that the stamp image 100 is changed, the edit process is executed again by using an undo process (returning to the previous operation) or a deleting process. In contrast, in the process of the present embodiment, since the user can newly paste the desired stamp image 100 while retaining the attributes (preceding edit details (position, size, direction (rotation angle)) of the stamp image 100 before the change, it is possible to further improve the user's operability.

Next, when the user is satisfied with the pattern (design), position, dimensions (size), and direction (rotation angle) of the stamp image 100 currently displayed on the edit screen 400, the user fixes the stamp image 100 (making such a state that an operation of moving, scaling-up/down, rotating, etc. of the stamp image 100 is unable).

Conventionally, when the stamp image 100 is fixed, the user performs a touch operation to an arbitrary position on the display screen 300 to fix the stamp image 100. However, as described above, in the stamp image pasting process according to the present embodiment, the new stamp image 100 is possibly selected by a touch operation at an arbitrary position within the contents palette 102 by the user. Similarly, the stamp image 100 is also possibly moved by a touch operation within the operation region 200 by the user. Therefore, in the present embodiment, the stamp image 100 is fixed by a touch operation by the user in a region other than the contents palette 102 and other than the operation region 200. With this configuration, it is possible to improve the operability of the stamp image pasting process. A fixing process of the stamp image 100 in the present embodiment will concretely be described below.

Returning to step S12 of the stamp image pasting process of FIG. 7, the controller 11 determines whether a touch is made on the screen. If the controller 11 determines in step S12 that a touch is made (YES in step S12), the controller 11 determines whether the touch is made in the contents palette 102 (step S13). If the controller 11 determines in step S13 that the touch is not made in the contents palette 102 (the touch is made in other than the contents palette 102) (NO in step S13), the controller 11 determines whether the touch is made in a region other than the operation region 200 (step S16).

If the controller 11 determines in step S16 that the touch is made in a region other than the operation region 200 (YES in step S16), the controller 11 fixes the selection of the stamp image 100 currently displayed on the edit screen 400 (step S17), and this process is terminated. It is noted that, if the controller 11 determines in step S16 that the touch is not made in a region other than the operation region 200 (NO in step S16), the controller 11 returns to the process of step S12.

### (a) First Modified Embodiment

When the once fixed stamp image 100 is selected again on the edit screen 400, the controller 11 may provide control such that the stamp image 100 can be edited again. In this case, for example, a re-edit button, which enables the scaling-up/down and rotation operation, may be displayed. Further the re-edit button may be configured to enable operations of changing upper/lower positions between the stamp images 100 and changing upper/lower positions relative to a photographed person (changing layers).

### (b) Second Modified Embodiment

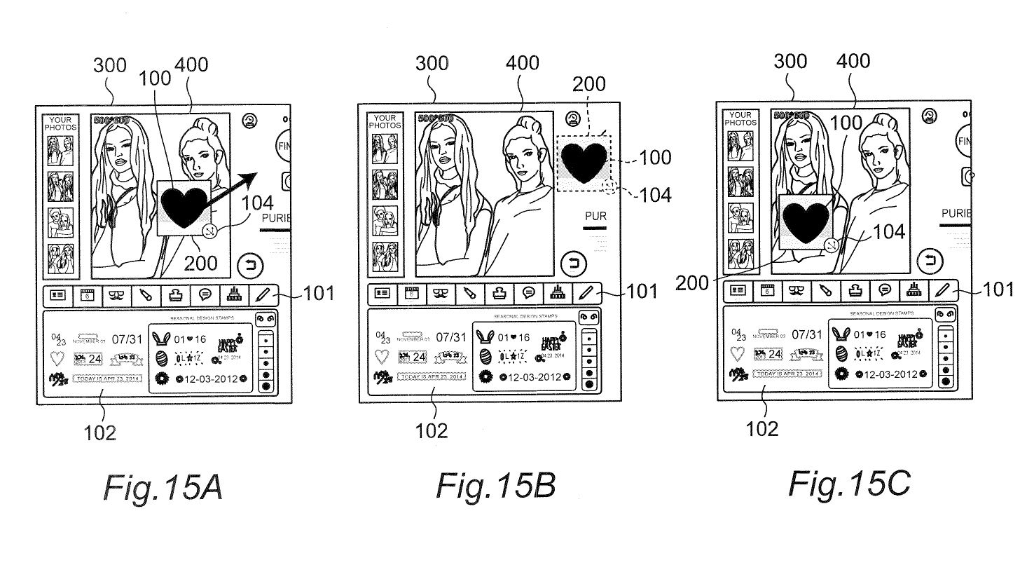

As shown in FIG. 15, the controller 11 may provide control such that portions of the stamp image 100 (including the operation button 104) and the operation region 200 placed outside the edit screen 400 disappear from the screen. For example, as shown in FIG. 15A, when the operation region 200 is dragged by the user in the arrow direction, a portion (dash line portion) located outside the edit screen 400 is not displayed (FIG. 15B). Subsequently, when the user brings the operation region 200 back onto the edit screen 400 by a drag continued from FIG. 15A, the disappearing portion is displayed again (FIG. 15C). At this time, the user can edit the stamp image 100 again. In addition, in case that the stamp image 100 and the operation region 200 are entirely located outside the edit screen 400 and the touch is released, the controller 11 may provide control such that the stamp image 100 is fixed. The user can use this operation as the trash box function as described above. That is, when the user discards the stamp image 100, the user can drag the stamp image 100 to the outside of the edit screen 400 and releases the touch to discard the stamp image 100 without selecting the trash box function.

### (c) Third Modified Embodiment

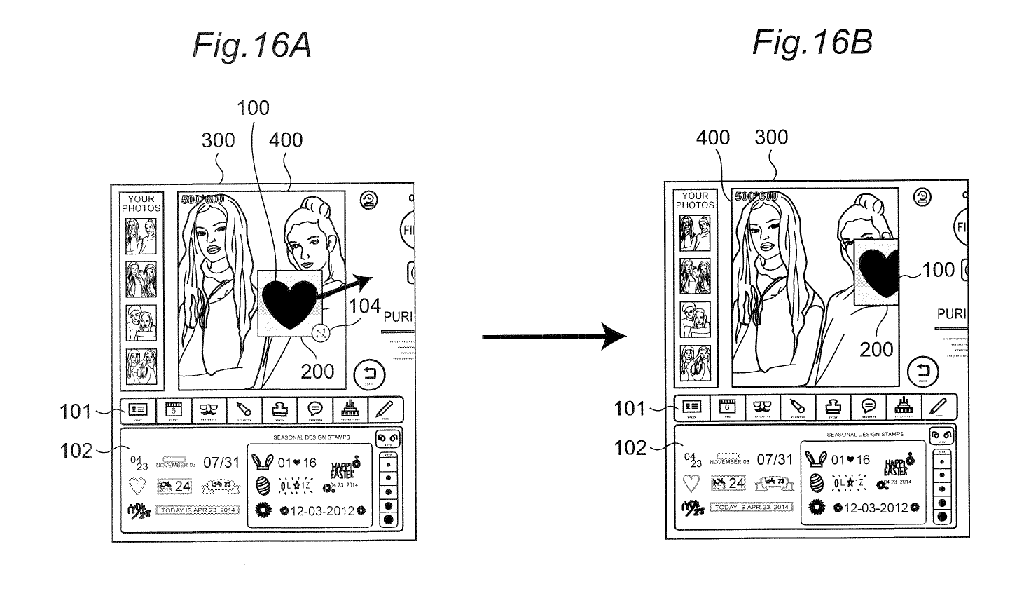

As shown in FIG. 16, the controller 11 may provide control such that portions of the stamp image 100 (including the operation button 104) and the operation region 200 placed outside the edit screen 400 disappears from the screen. When the operation region 200 is dragged by the user in the arrow direction as shown in FIG. 16(a), a portion located outside the edit screen 400 is not displayed (FIG. 16(b)). In addition, when the user brings the operation region 200 back onto the edit screen 400 by a drag continued from FIG. 16(a), the disappearing portion is displayed again (FIG. 16(a)). At this time, the user can edit the stamp image 100 again. In addition, in case that the stamp image 100 and the operation region 200 are entirely located outside the edit screen 400 and the touch is released, the controller 11 may provide control such that the stamp image 100 is fixed. The user can use this operation as the trash box function described above. That is, when the stamp image 100 is discarded, the user can drag the stamp image 100 to the outside of the edit screen 400 and releases the touch to discard the stamp image 100 without selecting the trash box function. In this example, although the controller 11 provides control such that the operation button 104 disappears when the operation button 104 is located outside the edit screen 400, the controller 11 may provide control so as to change the position of display of the operation button 104. In this case, the user can perform the rotation and scaling-up/down operation.

### (d) Fourth Modified Embodiment

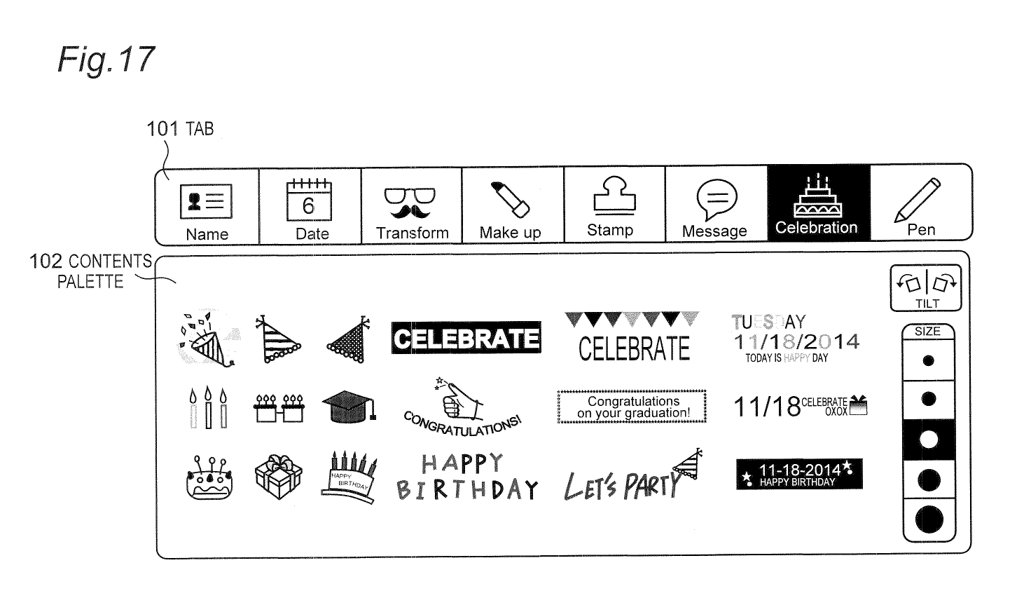

As shown in FIG. 17, the controller 11 may provide control such that the non-editable stamp images 100 are collected and displayed within the one contents palette 102. As shown in FIG. 17, for example, in case that a user, who plays a game after a graduation ceremony selects (presses) “congratulations!” as the stamp image 100, the user hardly changes the stamp image 100 of “congratulations!” to the stamp image 100 representative of birthday unless the user plays the game on the user's birth day. Rather, the user may feel annoyed with a button such as the operation button 104 displayed with such the stamp image 100. Therefore, since it is not necessary to retain details (attributes) of the previous operation for these hardly changed stamp images 100, these stamp images 100 may be collected in the one contents palette 102. With this configuration, the user can comfortably select and edit the stamp image 100, which matches the preference of the user.

### (e) Fifth Modified Embodiment

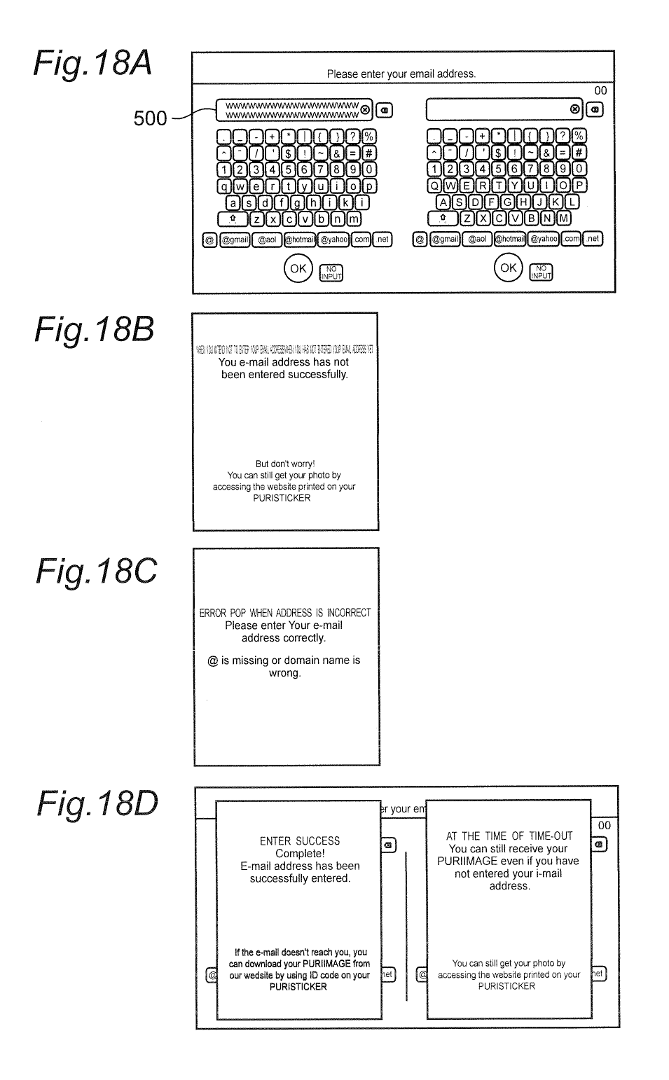

The controller 11 may provide control such that the image data edited by the user is transmitted to a user's smartphone etc. In this case, as shown in FIG. 18A, characters can be input in an e-mail address entry screen 500 up to 20 characters×2 lines (40 characters) (a new line is automatically started after 20 characters are input). It is noted that although characters in capital letters (caps lock) can be used for input, the screen is set such that “@” and “.” cannot be pressed twice. Further, in case that an entered e-mail address violates the RFC standard because of “@”, a “domain” button, “.com”, etc. at a first character, an error message is displayed after a transmission button is pressed as shown in FIG. 18B. In addition, in case that the transmission button is pressed without entering an e-mail address in the e-mail address entry screen 500, an error message is displayed as shown in FIG. 18B. Further, in case that the image data is successfully (completely) transmitted, a message as shown on the left side of FIG. 18D is displayed and, in case that the transmission is not completed within a predetermined time, a message as shown on the right side of FIG. 18D is displayed.

### 3. CONCLUSION

As described above, the photo sticker creating apparatus 1 according to the present embodiment includes:

a photographing device (21) configured to photograph a user to generate a photographed image;

a display device (11, 23) configured to display a content image selection screen (102) with which the user selects a content image to be composited with the photographed image out of a plurality of content images; and

an instruction receiving device configured to accept selection of a first content image by a user on the content image selection screen (102).

The display device (11, 23) configured to display an operation region (200) including the first content image, moves and displays the first content image in accordance with movement of the operation region (200) corresponding to an operation of the user, and fixes the selection of the first content image when detecting a touch made by the user in a region other than the content image selection screen (102) and other than the operation region (200).

With this configuration, in case that a small stamp image 100 such as eyelash is moved with a finger or a stylus pen, even if the stamp image (100) is hidden by a tip of the finger or the stylus pen, the user can position the stamp image while confirming the position of the stamp image (100) in detail by touching the operation region without touching the stamp image (100) itself.

In addition, in case that the user selects a second content image after an attribute is changed for the first content image, the display device (11, 23) displays the second content image with the same attribute as the attribute of the first content image.

With this configuration, in case that a content image within the contents palette is replaced, the content image can be replaced with a new content image pasted while retaining the attribute (position, size, direction (rotation angle)) of the content image before the replacement. Therefore, the edit time and effort of the stamp image can be reduced.

### OTHER EMBODIMENTS

The various ideas described in the embodiments can appropriately be combined and can appropriately be changed, replaced, added, omitted, etc., based on common general technical knowledge of those skilled in the art. Other configuration applicable to the ideas disclosed in the embodiments will be described below.

The order of the processes may appropriately be changed in the operation of the example of the photo sticker creating apparatus shown in the flowchart of FIG. 5. For example, although the background selection process (S3) is executed before the photographing process (S4) in the flowchart of FIG. 5, the background selection process may be executed after the photographing process. In addition, although the layout selection process (S5) is executed after the photographing process (S4), the layout selection process may be executed before the photographing process.

The ideas shown in the above embodiments are applicable to an apparatus other than the photo sticker creating apparatus. That is, the ideas disclosed in the above embodiments are applicable to any image processing apparatus that is an apparatus compositing a composition image with a photographed image and that displays a selection screen for selecting a composition image to be composited with the photographed image.

The embodiments described above disclose the following ideas of an image processing apparatus etc. It is noted that the photo sticker creating apparatus 1 is one example of an image processing apparatus. The camera 21 is one example of a photographing device. Each of the storage device 12, the removable medium 15, and the RAM 17 is one example of a storage device. Each of a background set and a background image is one example of a composition image. A base image 71 is one example of an image selection region. The background selection screen 200 is one example of a selection screen. The controller 11 is one example of a composition processing portion. The touch panel monitor 23 is one example of an instruction receiving device. A configuration of combination of the controller 11 and the touch panel monitor 23 is one example of a display device. Each of the printers 51a, 51b and the printing section 130 is one example of a printing section. In this case, the display device displays a content image selection screen (the contents palette 120) for allowing a user to select a content image to be composited with a photographed image out of a plurality of content images within the contents palette 120. In addition, the instruction receiving device accepts selection of a first content image by a user on the content image selection screen. In addition, the display device generates and displays the operation region 200 including the first content image, moves and displays the first content image in accordance with movement of the operation region 200 moved by the user, and fixes the selection of the first content image when detecting a touch made by the user in a region other than the content image selection screen and other than the operation region 200. Further, the display device can change an attribute of the content images and, in case that the user selects a second content image after an attribute is changed for the first content image, the display device displays the second content image with the same attribute as the attribute of the first content image. Furthermore, the display device generates and displays the operation button 104 superimposed on or located close to the operation region for allowing the user to execute an image process such as a process of rotating, scaling up, and scaling down the first content image. In addition, in case that the content image is scaled down, the display device provides control so as to retain the operation region 200 in a region larger than the content image.

(1) The image processing apparatus (1) includes:

a photographing device (21) configured to photograph a user to generate a photographed image;

a display device (11, 23) configured to display a content image selection screen (102) with which the user selects a content image to be composited with the photographed image out of a plurality of content images; and

an instruction receiving device configured to accept selection of a first content image by a user on the content image selection screen (102).

The display device (11, 23) displays the operation region (200) including the first content image, moves and displays the first content image in accordance with movement of the operation region (200) corresponding to an operation of the user, and fixes the selection of the first content image when detecting a touch made by the user in a region other than the content image selection screen (102) and other than the operation region (200).

With this configuration, in case that a small stamp image 100 such as eyelash is moved with a finger or a stylus pen, even if the stamp image (100) is hidden by a tip of the finger or the stylus pen, the user can position the stamp image while confirming the position of the stamp image (100) in detail by touching the operation region without touching the stamp image (100) itself.

(2) The display device (11, 23) changes an attribute of the first content image.

(3) The display device (11, 23) displays a second content image with the same attribute as the attribute of the first content image in case that the user selects the second content image after an attribute is changed for the first content image.

With this configuration, in case that a content image within the contents palette is replaced, the content image can be replaced with a new content image pasted while retaining the attribute (position, size, direction (rotation angle)) of the content image before the replacement. Therefore, the edit time and effort of the stamp image can be reduced.

(4) In addition, the display device (11, 23) displays an operation button (104) with which the user changes an attribute for the selected content image, the operation button (104) being superimposed on or located close to the operation region.

With this configuration, it is possible to improve the operability of edit of the content image by the user.

(5) In addition, the attribute of the content image includes a position, a size, and/or a rotation angle of the content image.

With this configuration, it is possible to improve the operability of the rotating, scaling-up, and scaling-down operations of the content image for the user.

(6) In addition, the attribute is changed by rotating, scaling-up, and/or scaling-down the content image.

With this configuration, the user can acquire the content image, which matches the preference of the user.

(7) The display device (11, 23) provides control so as to retain the operation region 200 in a region larger than the content image in case that the content image is scaled down.

With this configuration, by touching the operation region 200 without touching the stamp image itself, the user can position the stamp image 100 while confirming the position of the stamp image 100 in detail without hiding the stamp image 100 with a finger or a stylus pen.

(8) An image processing method includes:

photographing a user to generate a photographed image;

displaying a content image selection screen with which the user selects a content image to be composited with the photographed image out of a plurality of content images; and

receiving selection of a first content image by a user on the content image selection screen.

The displaying includes:

displaying an operation region including the first content image,

moving and displaying the first content image in accordance with movement of the operation region corresponding to an operation of the user, and

fixing the selection of the first content image when detecting a touch made by the user in a region other than the content image selection screen and other than the operation region.

(9) In addition, the displaying includes:

displaying the second content image with the same attribute as the attribute of the first content image in case that the user selects a second content image after an attribute is changed for the first content image.

(10) A non-transitory computer-readable storage medium according to the present invention stores an image processing program for allowing a computer to execute the image processing method as described above.

What is claimed is:

1. An image processing apparatus comprising:
a photographing device configured to photograph a user to generate a photographed image;
a display device configured to display a content image selection screen with which the user selects a content image to be composited with the photographed image out of a plurality of content images; and
an instruction receiving device configured to receive selection of a first content image by a user on the content image selection screen,
wherein the display device displays an operation region including the first content image, moves and displays the first content image in accordance with movement of the operation region corresponding to an operation of the user, and
the display device fixes the selection of the first content image when detecting a touch made by the user in a region other than the content image selection screen and other than the operation region.

2. The image processing apparatus according to claim 1,
wherein the display device changes an attribute of the first content image.

3. The image processing apparatus according to claim 2,
wherein the display device displays a second content image with the same attribute as the attribute of the first content image in case that the user selects the second content image after an attribute is changed for the first content image.

4. The image processing apparatus according to claim 2,
wherein the display device displays an operation button with which the user changes an attribute for the selected content image, the operation button being superimposed on or located close to the operation region.

5. The image processing apparatus according to claim 2,
wherein the attribute of the content image includes a position, a size, and/or a rotation angle of the content image.

6. The image processing apparatus according to claim 2,
wherein the attribute is changed by rotating, scaling-up, and/or scaling-down the content image.

7. The image processing apparatus according to claim 6,
wherein the display device provides control so as to retain the operation region in a region larger than the content image in case that the content image is scaled down.

8. An image processing method comprising:
photographing a user to generate a photographed image;
displaying a content image selection screen with which the user selects a content image to be composited with the photographed image out of a plurality of content images; and
receiving selection of a first content image by a user on the content image selection screen,
wherein the displaying includes
displaying an operation region including the first content image,
moving and displaying the first content image in accordance with movement of the operation region corresponding to an operation of the user, and
fixing the selection of the first content image when detecting a touch made by the user in a region other than the content image selection screen and other than the operation region.

9. The image processing method according to claim 8,
wherein the displaying includes
displaying the second content image with the same attribute as the attribute of the first content image in case that the user selects a second content image after an attribute is changed for the first content image.

10. A computer-readable storage medium storing an image processing program for allowing a computer to execute the image processing method according to claim 8.
